(19) United States
(12) Patent Application Publication
(10) Pub. No.: US 2015/0023564 A1
(43) Pub. Date: Jan. 22, 2015

(54) SYSTEM AND METHOD FOR ESTIMATING POROSITY DISTRIBUTION IN SUBTERRANEAN RESERVOIRS

(71) Applicants: Marina Hruska, San Ramon, CA (US); Mark Tadeusz Skalinski, San Ramon, CA (US)

(72) Inventors: Marina Hruska, San Ramon, CA (US); Mark Tadeusz Skalinski, San Ramon, CA (US)

(73) Assignee: CHEVRON U.S.A. INC., San Ramon, CA (US)

(21) Appl. No.: 13/945,690

(22) Filed: Jul. 18, 2013

(51) Int. Cl. E21B 49/00; G06T 7/40

(52) U.S. Cl. CPC E21B 49/00; G06T 7/40
USPC 382/109

(57) ABSTRACT

A system and method for estimating porosity distribution in a region of interest of a geologic formation from a resistivity image log representative of the geologic formation is disclosed. A normalization factor representative of a rock matrix based on a first resistivity value and an image point factor based on a second resistivity value are calculated and compared to identify points in the resistivity image log that correspond to the secondary porosity. The normalization factor and image point factor are recalculated based on a different first resistivity value and a different second resistivity value as necessary to identify additional points in the resistivity image log that correspond to the secondary porosity until a termination criterion is met. The method may further include a porosity calibration operation and one or more artifact corrections.

### FIELD OF THE INVENTION

The present invention relates generally to methods and systems for processing well logs and, in particular, methods and systems for estimating porosity distribution, including secondary porosity, in subterranean reservoirs.

### BACKGROUND OF THE INVENTION

Hydrocarbon exploration and production is aided by understanding the porosity distribution in subterranean reservoirs. In some geologic formations, particularly carbonate formations, the porosity distribution may be significantly non-uniform on one or more scales from core plug scale to interwell distances.

Porosity may be estimated by inspection of core samples or evaluation of well logs. However, these approaches have difficulties when pore space structure changes on a scale shorter than the spacing of the core measurements or shorter than the log sensitivity. In the presence of very large pores (vugs, for example), core samples may not be large enough to capture a single large vug occurrence nor a representative distribution of vugs needed to characterize fluid flow on a well-scale. These problems are common in many carbonate fields.

### SUMMARY OF THE INVENTION

Described herein are implementations of various approaches for a computer-implemented method for estimating porosity distribution in regions of interest of geologic formations.

A computer-implemented method for estimating porosity distribution in a region of interest of a geologic formation from a resistivity image log representative of the geologic formation including calculating a normalization factor representative of a rock matrix based on a first resistivity value; calculating a image point factor based on a second resistivity value; comparing the image point factor and the normalization factor to identify points in the resistivity image log that correspond to the secondary porosity; recalculating the normalization factor and the image point factor based on a different first resistivity value and a different second resistivity value; re-comparing the recalculated normalization factor and the recalculated image point factor to identify additional points in the resistivity image log that correspond to the secondary porosity; and repeating the recalculating and re-comparing steps until a termination criterion is met is disclosed. The method may further include a porosity calibration operation and one or more artifact corrections.

In another embodiment, a computer system including a data source or storage device, at least one computer processor and a user interface to implement the method for estimating porosity distribution in a region of interest of a geologic formation is disclosed.

In yet another embodiment, an article of manufacture including a computer readable medium having computer readable code on it, the computer readable code being configured to implement a method for estimating porosity distribution in a region of interest of a geologic formation is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a diagram of porosity in a geologic formation;

FIG. 2 is a flowchart of an embodiment of the invention;

FIG. 3A is a diagram of a resistivity imaging tool;

FIG. 3B is a diagram of a part of the resistivity imaging tool;

FIG. 4 illustrates an intermediate step of an embodiment of the invention;

FIG. 5 illustrates results for porosity distribution and secondary porosity estimate from an embodiment of the invention; and

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications networks. In a distributed computing environment, program modules may be located in both local and remote computer storage media including memory storage devices. The present invention may also be practiced as part of a down-hole sensor or measuring device or as part of a laboratory measuring device.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to estimating porosity distribution in a geologic formation, particularly in a carbonate formation with secondary porosity (such as without limitation, vugs, molds or dissolution enhanced fractures). Significantly non-uniform porosity distribution is common in carbonate reservoirs on all lengthscales of routine measurements in oil exploration and production, from core plug scale to interwell distances. An accurate representation of porosity is desirable in building reservoir models for estimation of oil-in-place and recoverable reserves.

In rocks with simple, uniform pore systems filled with saline water, Archie's law relates porosity φ to the formation resistivity factor F, as

$$F = \frac{1}{{φ}^{m}}$$

where F is the ratio of resistivity R₀ of fully water-saturated rock and resistivity of formation water R_{w}

$$F = \frac{{R}_{0}}{{R}_{W}}$$

and m is the lithology exponent or cementation factor. Those skilled in the art are aware that, when hydrocarbons are present, the resistivity index I, which is a ratio of resistivity of the rock containing hydrocarbons Rₜ to the resistivity of the fully water-saturated rock R₀, i.e. I=Rₜ/R₀, is related to the water saturation S_{w} of the rock as

$$I = \frac{1}{{S}_{w}^{n}}$$

where n is the saturation exponent. In sandstones, it has been shown that m and n are very nearly equal to 2, and using the two relations the well-known Archie equation is obtained:

$${S}_{w}^{n} = \frac{{R}_{W}}{{R}_{t}} / {φ}^{m} .$$

At least two conditions exist in which the saturation exponent n can be significantly different than 2: in oil-wet reservoirs where oil coats grains and starts blocking pore throats and suppressing electrical conduction, even at low oil saturation, and in rocks with non-uniform pore space. The cementation factor m is related to the tortuosity of current paths, taking a value of 1 in an idealized reservoir where fractures offer a straight conductive path without interaction with granular (inter-grain) porosity. On the other hand, isolated pores have porosity but do not contribute to rock conductivity, effectively raising F and m for the host rock.

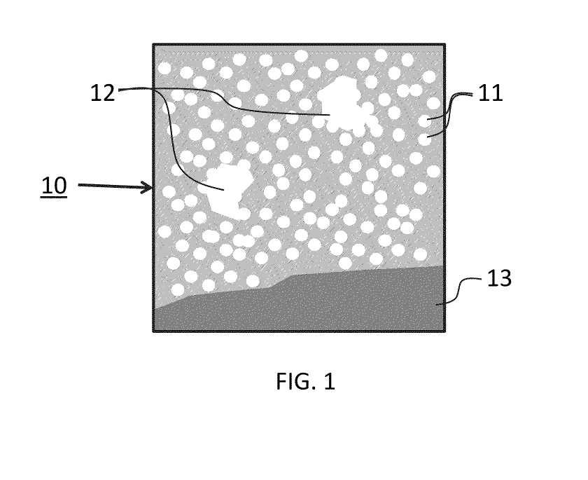

In carbonates, approaches which determine coefficients m and n from core or log measurements have been used. These approaches may have difficulties when the pore-space structure changes on a lengthscale shorter than the spacing of core measurements or shorter than the log sensitivity. In the presence of very large pores (vugs, for example), core samples may not be large enough to capture a single vug occurrence nor a representative distribution of vugs needed to characterize fluid flow on a wellscale. Both occurrences, of variations in pore-space structure occurring on small lengthscales and occurrence of vugs, are very common in many carbonate fields. FIG. 1 shows a representative diagram of porosity in a carbonate formation 10. The rock matrix has pores 11. There may be secondary porosity such as vugs 12. In some locations, the porosity may be very low, essentially zero, such as the tight rock 13. When these tight rock regions occupy layers of thickness larger than the resolution of porosity logs, their presence can be found from the total porosity log being very low (for example below 1%). This example is not meant to be limiting as the determination of a region of tight rock may be complicated by artifacts in the porosity log. In the cases of some minerals, tight regions can be identified from core and a minimum resistivity image value in such regions can be inferred from the image and used as a cut-off to identify such tight regions from image in other regions of the well.

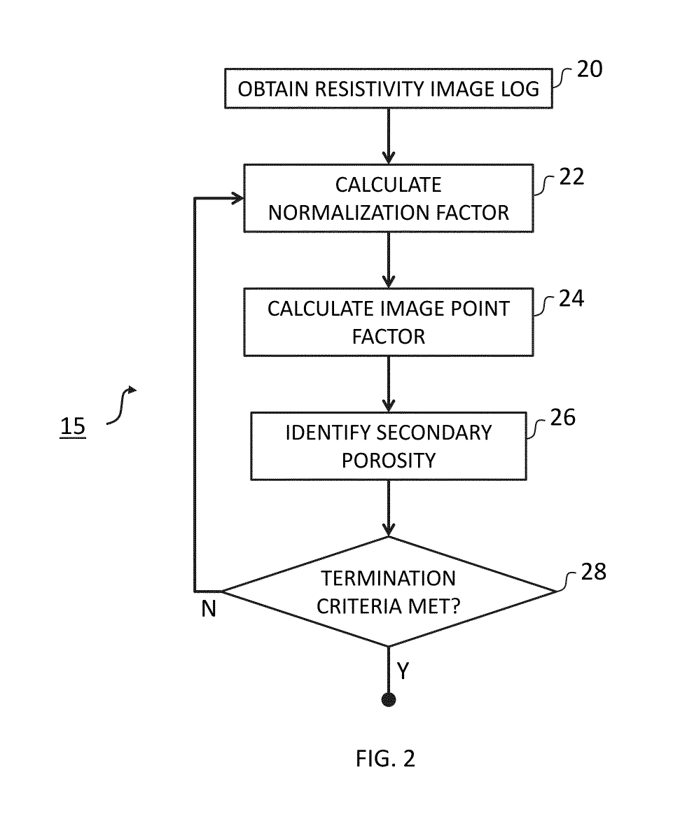

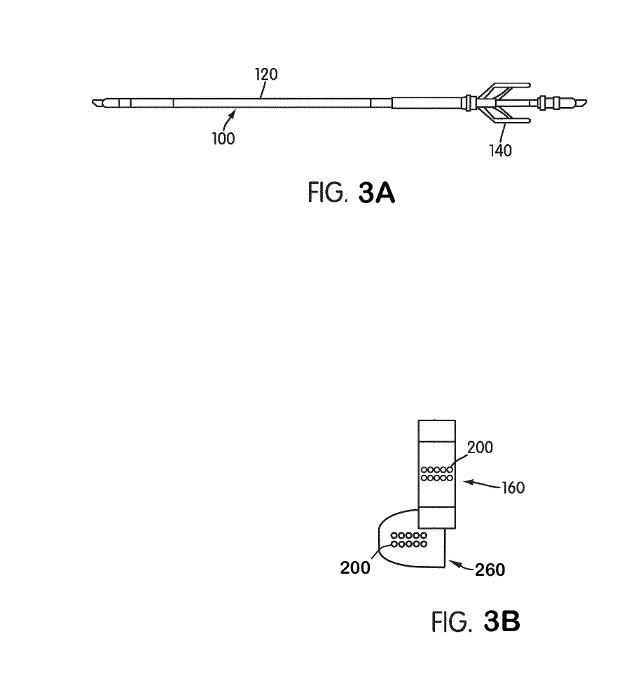

As indicated in method 15 of FIG. 2, the present invention obtains resistivity image log(s) (operation 20) from which the porosity distribution is estimated. Resistivity image logs have a resolution significantly higher than conventional open-hole resistivity logs and display results of an array of electrode measurements around the borehole as a depth and azimuth-dependent image. An example of a resistivity image tool may be seen in FIGS. 3A and 3B.

The probe may be a multi-trace or multi-pad measurement probe. For example, FIG. 3A illustrates a probe 100 for use in borehole characterization that includes a generally elongated shaft 120 having at one end a number of outwardly extending members 140. The outwardly extending members 140 may each include a pad 160 (shown in more detail in FIG. 3B) for interrogating a region of a borehole. The illustrated pad 160 includes a plurality of pairs of sensors 200 for monitoring a current which flows as a result of applying an alternating exciting voltage between an electrode located elsewhere on the tool.

In use, the probe 100 is generally lowered into the borehole to be characterized. Upon reaching an appropriate depth, which may be the bottom of the hole, or a selected intermediate depth, the probe is retrieved and measurements are taken as the probe rises through the material. In many cases, the probe 100 will have four pads 160 so that the hole may be characterized in four regions with distinct azimuths. In another example, the probe 100 may have six pads 160 that characterize regions around six distinct azimuths. The pad 160 may be accompanied by a flap 260 which also has a plurality of pairs of sensors 200.

The sensors 200 on the pad 160 and/or the flap 260 measure the electrical current that passes through the geologic formation and is proportional to the formation conductivity. Each sensor 200 will measure the current in its immediate vicinity, thereby measuring the conductivity of the geologic formation directly facing it. Resistivity is inversely proportional to the measured current and the coefficient of proportionality is the same for all electrodes within a homogeneous region. The coefficient of proportionality is well approximated as the same for all electrodes in other cases provided the number of electrodes is large. Measurement results are processed to obtain an array referred to in the art as the raw image. For better contrast in viewing, the image is often processed further. However, to retain relation of the image values to resistivity, only a calibration of the raw image to a conventional shallow-resistivity measurement is needed, without contrast enhancement procedures.

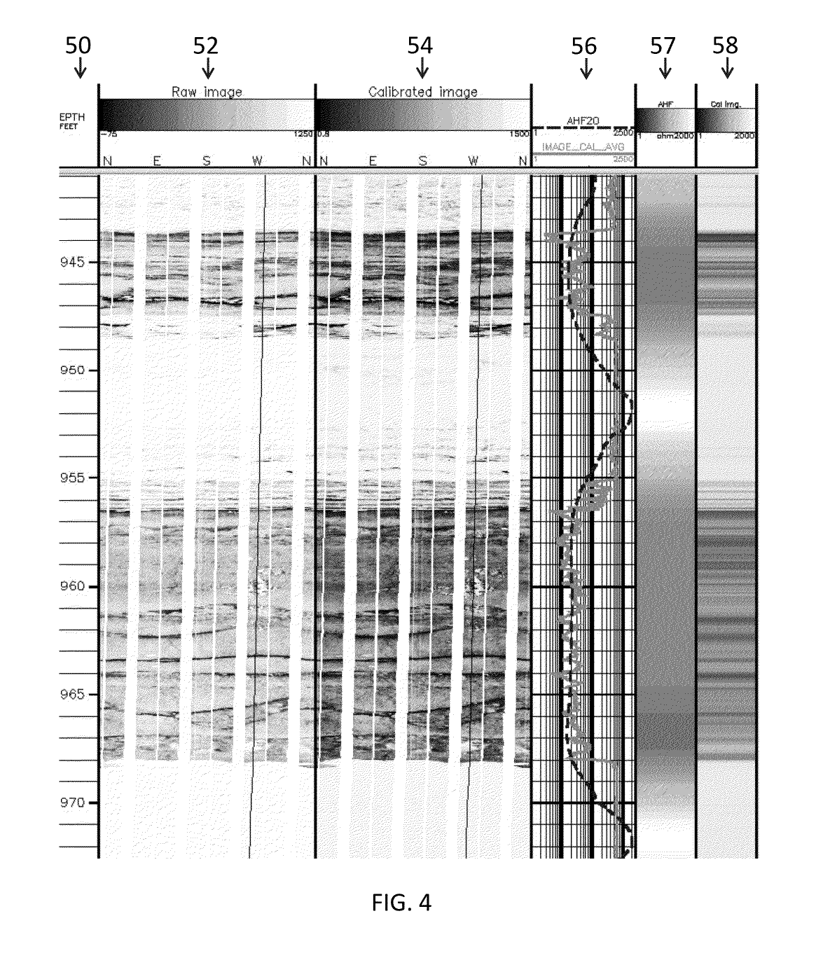

FIG. 4 shows an example of a raw image log in column 52, from data recorded by a Schlumberger Fullbore MicroImager (FMI) resistivity imaging tool. The four measurements from the four pad-flaps appear as individual columns at locations in image corresponding to the azimuth of their measurement location in the borehole. Column 50 represents the depth in the borehole (with reference altered for confidentiality). Column 54 shows the calibrated image. Column 56 shows the calibration value as the dashed dark line and the resultant average calibrated image value as the light solid line. The calibration value is also shown in gray-scale in column 57 and the average calibrated image value is shown in column 58.

Methods have been developed to model porosity for each point in the image using Archie's equation and may include using constraints from other porosity information and a conventional resistivity measurement. One method estimates the fraction of porosity which corresponds to regions of secondary porosity by examining the distribution of image-derived porosity and statistically defining cutoff values on porosity. However, this type of analysis is not appropriate for conductive minerals and shale. This method may overestimate secondary porosity in regions where the rock matrix has significant porosity variations with abrupt onset azimuthally (around the borehole).

Referring again to FIG. 2, obtaining the resistivity image log (operation 20) may include running the probe in the borehole or receiving the data recorded by the tool, processing it to obtain a raw image and calibrating the raw image. Once the data has been obtained, the present invention assumes that the rock matrix obeys Archie's law or a similar relation

$${φ}_{i} = {( \frac{1}{{S}_{w}^{n}} \frac{{R}_{w}}{{r}_{i}} )}^{1 / m} ≡ \frac{C}{{r}_{i}^{1 / m}} , \qquad ( 1 )$$

where φᵢ and rᵢ are respectively the rock matrix porosity and resistivity in the i-th cell contributing to the i-th electrode of the fine-resolution resistivity measurement, R_{w} is the resistivity of the saline water in the matrix pores, and C is a constant for constant water saturation S_{w}, salinity and temperature around the borehole at the given reference depth. The rock matrix excludes regions of tight rock where porosity can be assumed to be zero (FIG. 1, tight rock 13).

Expressing the total volume of voids in a rock via volume of pores in the matrix and of voids in the region affected by secondary porosity (vugs 12 in FIG. 1), the constant C, which is set for a constant water saturation, salinity and temperature around the borehole at a given reference depth, can be related to a reference porosity log φ:

$$φ \times {V}_{total} = {V}_{cell} \times {\sum }_{i = 1}^{{N}_{ma}} \frac{C}{{r}_{i}^{1 / m}} + {V}_{sec} \qquad ( 2 )$$

where φ may be determined from core measurements or well logs such as a neutron-density crossplot, V_{sec} is the volume sensed by the fine-resolution measurement as occupied by secondary porosity, Vₜₒₜₐₗ is the volume of the borehole region approximately shaped as a cylindrical shell, which is probed by the tool which provided reference porosity at the given depth and comprises of non-overlapping cells each sensed by one electrode of the fine-resolution resistivity measurement, V_{cell} is the volume of the region (cell) most directly probed by the resistivity measurement of high resolution (i.e. for a resistivity image tool this is exclusive volume assigned to be responsible for a given pixel in image, though the sensitive volume for the tool is larger). In an embodiment, we assume that the ratio V_{sec}/Vₜₒₜₐₗ is well approximated by the ratio of the number of resistivity image pixels occupied by secondary porosity to the total number of resistivity image pixels for the region. This assumption is not to be taken as limiting the scope of the invention, as the ratios under consideration can be assumed to be related with another coefficient of proportionality characteristic of the region or formation. Further, Nₘₐ is the number of cells occupied by matrix, and Vₜₒₜₐₗ and V_{cell} are related via the total number of cells N as

Vₜₒₜₐₗ=N×V_{cell} (3)

while Vₜₒₜₐₗ and V_{sec} are related as

$$\frac{{N}_{ma}}{N} = 1 - \frac{{N}_{sec}}{N} - \frac{{V}_{tight}}{{V}_{total}} ≡ 1 - v - \frac{{V}_{tight}}{{V}_{total}} \qquad ( 4 )$$

where V_{tight} is the volume of the region occupied by tight rock of essentially no porosity and N_{sec} is the number of cells that are sensed as occupied by secondary porosity by a fine-resolution resistivity measurement. We call υ=N_{sec}/N the fractional volume sensed as secondary porosity. In a measurement of a resolution much finer than the characteristic size of macropores involved in secondary porosity, N_{sec}=V_{sec}/V_{cell} and N_{sec}/N=V_{sec}/Vₜₒₜₐₗ. However, for a measurement of resolution of the same order as the size of macropores sensed, the measurement may detect the presence of a void in a region where porosity is significantly less than 100% for a significant portion the total number of pixels which are sensing that void.

Dividing the left and right hand side of the equation (2) with V_{V}ₜₒₜₐₗ, and using equations (3) and (4) one obtains

$$φ = ( 1 - v - \frac{{V}_{tight}}{{V}_{total}} ) \times \frac{1}{{N}_{ma}} \times {\sum }_{i = 1}^{{N}_{ma}} \frac{C}{{r}_{i}^{1 / m}} + {φ}_{v} \qquad ( 5 )$$

Here we call φ_{υ} secondary porosity as it is the ratio of volume occupied by secondary porosity to the total volume. This can be related to the fractional volume υ as φ_{υ}=υ×φ_{high} where φ_{high} is the average porosity assigned to the region in which the fine-resolution resistivity measurements can sense the void. In a measurement of resolution much finer than the size of regions occupied by secondary porosity, φ_{high}=1 but for resolution of the same order as for example one of dimensions of vugs sensed, this parameter is about 50%. These numbers are examples of common parameter values but are not meant to be limiting; other average porosity values are possible and fall in the scope of the present invention.

From equations (1) and (5), the porosity of a rock matrix cell can be expressed as

$${φ}_{i} = \frac{φ - {φ}_{v}}{1 - v - \frac{{V}_{tight}}{{V}_{total}}} \times \frac{\frac{1}{{r}_{i}^{1 / m}}}{{〈 \frac{1}{{r}^{1 / m}} 〉}_{ma}} , \qquad ( 6 )$$

where [symbol] r^{1/m} [symbol] ₘₐ is the average of inverse mth root of the fine-resolution resistivity over the matrix cells:

$${〈 \frac{1}{{r}^{1 / m}} 〉}_{ma} = \frac{1}{{N}_{ma}} {\sum }_{j = 1}^{{N}_{ma}} \frac{1}{{r}_{j}^{1 / m}} \qquad ( 7 )$$

The equation (6) is not applicable in cases where

$$\frac{( φ - {φ}_{v} ) \times \frac{1}{{r}_{i}^{1 / m}}}{( 1 - v - \frac{{V}_{tight}}{{V}_{total}} ) \times {〈 \frac{1}{{r}^{1 / m}} 〉}_{ma}} > 1 , \qquad ( 8 )$$

which can occur with a high proportion occupied by tight regions or for pixels in highly conductive regions (where the value of rᵢ is too low relative to its peers considered to be in the matrix). It is common to impose cut-offs on resistivity or conductivity to delineate regions of tight rock or regions of secondary porosity. The practical aspect of the restriction in the inequality (8) is that it can be used iteratively to find the maximum resistivity cut-off for secondary porosity voids when the region of tight rock is not present or has already been delineated, e.g. with a cut-off r_{tight} imposed as a minimum resistivity for a point to belong to the tight rock region. Starting from the lowest resistivity rᵢ in a region for which porosity distribution is calculated, the numerator in the inequality (8), which can be called the image point or cell factor, is found. Referring again to FIG. 2, the image point factor is calculated at operation 24 as

$$( φ - {φ}_{v} ) \times \frac{1}{{r}_{i}^{1 / m}} ,$$

with the secondary porosity φ_{υ}=0 corresponding to no cells yet assigned to secondary porosity in the first iteration. Similarly the denominator in the inequality (8), which can be called the normalizing factor, can be calculated, as shown in FIG. 2 operation 22, with all cells (except for tight regions) belonging to the matrix, i.e. minimum resistivity taken into the average set to the lowest resistivity image value rₘᵢₙ in the region:

$$( 1 - v - \frac{{V}_{tight}}{{V}_{total}} ) \times {〈 \frac{1}{{r}^{1 / m}} 〉}_{r \geq {r}_{min} and cell not in tight region} .$$

Typically, method 15 is performed for a region of the borehole that is not larger than the resolution of the reference porosity log. The method 15 may be performed at multiple regions of interest, wherein the normalization factor and image point factors are calculated independently for each region of interest.

At operation 26 of method 15, the porosity is assigned based on the normalization factor and the image point factor. If the image point factor is smaller than the normalizing factor, equation (6) can be used to assign porosity to all cells which are not in the tight region (there the porosity is modeled as zero). If the image factor is not smaller than the normalizing factor, all cells of this resistivity are assigned to secondary porosity, and the minimum resistivity rₘᵢₙ for the matrix cells, the secondary porosity φ_{υ} and fractional volume υ are updated accordingly, whereby the minimum matrix resistivity is set to the next lowest resistivity value. If the secondary porosity does not exceed a reasonable limit (e.g. 25%), referred to as the termination criteria in FIG. 2, operation 28, the method proceeds to the next iteration, where the next lowest resistivity value is tested as to whether it satisfies inequality (8) which would qualify it for the lowest matrix resistivity. The example of 25% is not meant to be limiting; the termination criteria may be provided by the user based on any known or assumed properties of the geologic region of interest. An example is presence of very large vugs or caverns, and changes in caliper can be used to define a higher limit on secondary porosity in the termination criteria. The iterations are carried out until the inequality (8) is satisfied for rᵢ set to minimum resistivity in the matrix cells or the fractional volume v exceeds the high limit. In the latter case, the region of tight rock can be adjusted to exclude a larger portion of the region of interest (e.g. in the case of delineating by cut-offs, the largest resistivity considered to this point to belong to matrix is now reassigned to the tight rock, and the iterative method of assessing secondary porosity can proceed starting from 0 again. If no resistivity is found to satisfy the inequality (8) with υ<25%, for example, for the given tight rock volume, the iterative method can be carried out after successive adjustments to the tight rock volume until there are no more points with resistivity in the upper half of the resistivity image value range for the well. In such a case, the assessment is made from other log information as to whether this is e.g. a region of predominantly tight rock or of a high proportion of shale. Such an assessment then proceeds to assign the cell porosity to a constant for each of the two groups of cells, φ_{high}_{_{—}}ᵣₑₛ. and φ_{low}_{_{—}}ᵣₑₛ. (high resistivity and low resistivity group) according to whether there is clay or very tight rock in the region, observing that the porosity of the region has to match a reference porosity.

The high- and low-resistivity group of cells can be adjusted in regions of tight rock or clay when a correction of image artifacts is performed. In one embodiment, such a correction is done from considerations of geometry. It uses screening of the points in resistivity image identified to be in regions of secondary porosity, to identify likely clay layers or noise. If resistivity of clay and tight rock is reasonably assumed to be constant and this constant is known, this correction would involve adjustment to image values themselves, prior to entering the image porosity calculation. In a region where there is only tight rock and secondary porosity present, secondary porosity for the region is obtained as

φ_{υ}=∠−φ_{high}_{_{—}}ᵣₑₛ.×N_{high}/N

where N_{high} is the number of cells with high resistivity and whereby φ_{high}_{_{—}}ᵣₑₛ. is set to the average value for tight rock in the well.

Although method 15 of FIG. 2 shows the calculation of the image point factor 24 occurring after the calculation of the normalization factor 22, this is not meant to be limiting. These calculations may be done in any order or concurrently.

It may also be desirable to calibrate the method 15. This may be done by comparing the resistivity image log with core measurements. For example, in regions where there are multiple vugs of similar size displayed both in core and resistivity image, vug sizes in core can be used to deduce which points in image features belong to vugs and which may be conductive image artifacts. In one embodiment, such a calibration step corrects for artifacts by assigning a lower value to the local average porosity φ_{high} for secondary-porosity regions (e.g. vugs, mold size, etc.).

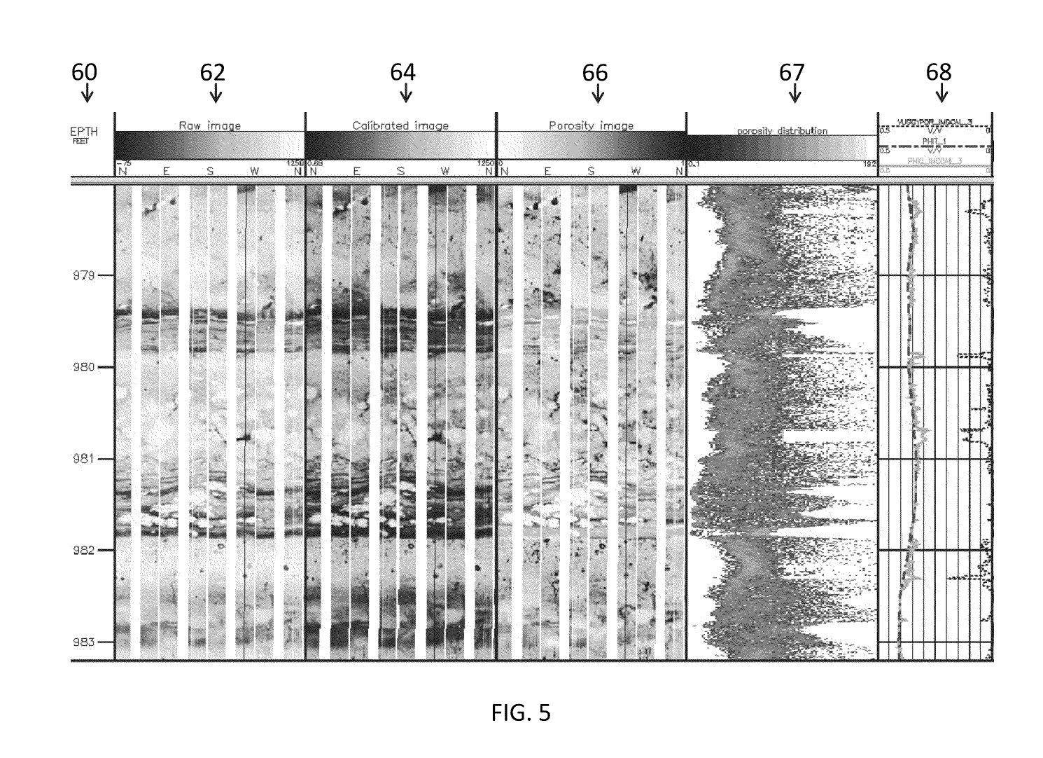

Once it is deduced which cells belong to the secondary porosity, each matrix cell is assigned porosity according to equation (6). An example of the intermediate and final results of method 15 may be seen in FIG. 5. Here, the depth is represented in column 60 and the raw image is seen in column 62. The calibrated image is in column 64. The porosity image is in column 66; the light shades indicate areas with low porosity and dark shades indicate higher porosity. The porosity is also represented in columns 67 and 68. Column 67 shows the porosity distribution and column 68 shows the average values for the secondary porosity (dark, short dashes), the total porosity (long dash, short dash), and the local matrix porosity (light gray, solid line). To obtain the total pore volume in matrix in the region of interest, the average local matrix porosity is multiplied by matrix volume. To obtain the total volume occupied by secondary porosity in the region of interest, secondary porosity is multiplied by the total volume of the region.

When the method 15 terminates, it is possible to validate the results. This may be done, for example, by identifying regions of high conductivity from other well logs such as a gamma-ray log and/or a caliper log and elimination of those regions and all adjacent high-conductivity points from secondary porosity.

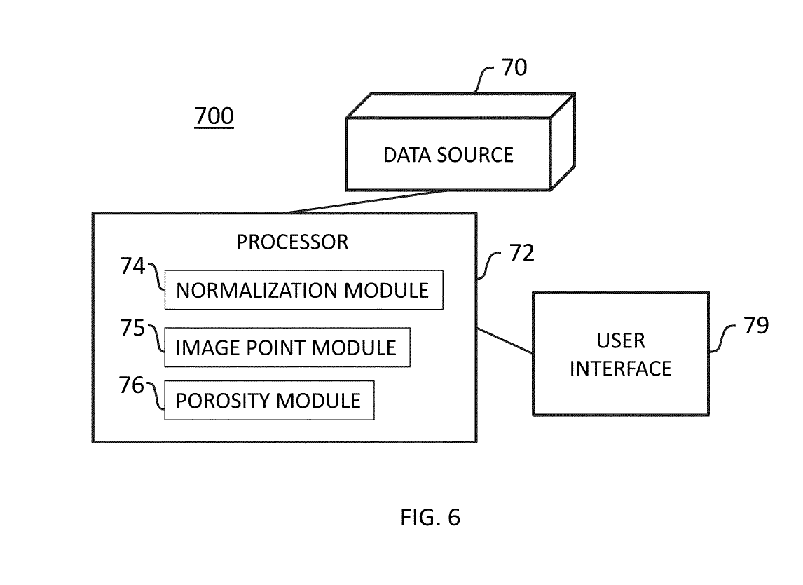

A system 700 for performing the method 15 of FIG. 2 is schematically illustrated in FIG. 6. The system includes a data source/storage device 70 which may include, among others, a data storage device or computer memory. The data source/storage device 70 may contain resistivity image log data. The data from data source/storage device 70 may be made available to a processor 72, such as a programmable general purpose computer. The processor 72 is configured to execute computer modules that implement method 15. These computer modules may include a normalization module 74 for calculating a normalization factor, an image point module 75 for calculating an image point factor, and a porosity module 76 for comparing the normalization factor and image point factor to determine where secondary porosity exists. These modules may be implemented more than once in an iterative manner. The system may include interface components such as user interface 79. The user interface 79 may be used both to display raw data and processed data and to allow the user to select among options for implementing aspects of the method. By way of example and not limitation, the porosity distribution computed on the processor 72 may be displayed on the user interface 79, stored on the data storage device or memory 70, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for estimating porosity distribution in a region of interest of a geologic formation, from a resistivity image log representative of the geologic formation, the method comprising:
a. calculating a normalization factor representative of a rock matrix based on a first resistivity value;
b. calculating an image point factor based on a second resistivity value;
c. comparing the image point factor and the normalization factor to identify points in the resistivity image log that correspond to the secondary porosity;
d. recalculating the normalization factor and the image point factor based on a different first resistivity value and a different second resistivity value;
e. re-comparing the recalculated normalization factor and the recalculated image point factor to identify additional points in the resistivity image log that correspond to the secondary porosity; and
f. repeating the recalculating and re-comparing steps until a termination criterion is met.

2. The method of claim 1 wherein the image point factor is calculated as:
$$( φ - {φ}_{v} ) \times \frac{1}{{r}_{i}^{1 / m}}$$
where φ is a reference porosity, φ_{υ} is a secondary porosity, m is a cementation factor, and rᵢ is the second resistivity value.

3. The method of claim 1 wherein the normalization factor is calculated as:
$$( 1 - v - \frac{{V}_{tight}}{{V}_{total}} ) \times {〈 \frac{1}{{r}^{1 / m}} 〉}_{ma}$$
where υ is a fractional volume representing the secondary porosity, V_{tight} is a volume of the rock formation of interest which is occupied by rock with substantially zero porosity, Vₜₒₜₐₗ is a volume of rock formation of interest, and
$${〈 \frac{1}{{r}^{1 / m}} 〉}_{ma} = \frac{1}{{N}_{ma}} {\sum }_{j = 1}^{{N}_{ma}} \frac{1}{{r}_{j}^{1 / m}}$$
where Nₘₐ is a number of cells in a volume of rock formation of interest which are occupied by the rock matrix, m is a cementation factor, and rⱼ is the resistivity image value at cell j and is not smaller than the first resistivity value, which is used to define cells belonging to the matrix.

4. method of claim 1, where the termination criterion is met when the image point factor for the matrix part of the region of interest is smaller than the normalization factor.

5. method of claim 2, where the termination criterion is reached when the secondary porosity ceases to be smaller than the reference porosity.

6. The method of claim 1 further comprising a porosity calibration step.

7. The method of claim 6 wherein the porosity calibration step is performed using information based on vug size, mold size, or combinations thereof.

8. The method of claim 7 wherein vug size or mold size is determined by core imaging analysis.

9. method of claim 1, further comprising applying an artifact correction of the resistivity image log prior to the calculating operations.

10. The method of claim 1, wherein the method is repeated at a plurality of regions of interest in the geologic formation.

11. method of claim 10, further comprising determining the porosity distribution after the termination criterion is met and applying an artifact correction to the porosity distribution wherein the artifact correction is calculated by identifying highly conductive regions not corresponding to secondary porosity using other logs.

12. method of claim 11, where other logs comprise a gamma-ray log.

13. method of claim 11, where other logs comprise a caliper log.

14. A system for estimating porosity distribution in a geologic formation of interest, the system comprising:
a. a data source containing well log data representative of the subsurface region of interest;
b. a computer processor configured to execute computer modules, the computer modules comprising:
i. a normalization module for calculating a normalization factor representative of a rock matrix based on a first resistivity value;
ii. an image point module for calculating a image point factor based on a second resistivity value;
iii. a porosity module for comparing the image point factor and the normalization factor to identify points in the resistivity image log that correspond to the secondary porosity; and
c. an user interface.

15. An article of manufacture including a computer readable medium having computer readable code on it, the computer readable code being configured to implement a method for estimating porosity distribution in a region of interest of a geologic formation, from a resistivity image log representative of the geologic formation, the method comprising:
a. calculating a normalization factor representative of a rock matrix based on a first resistivity value;
b. calculating an image point factor based on a second resistivity value;
c. comparing the image point factor and the normalization factor to identify points in the resistivity image log that correspond to the secondary porosity;
d. recalculating the normalization factor and the image point factor based on a different first resistivity value and a different second resistivity value;
e. re-comparing the recalculated normalization factor and the recalculated image point factor to identify additional points in the resistivity image log that correspond to the secondary porosity; and
f. repeating the recalculating and re-comparing steps until a termination criterion is met.
